(19) United States
(12) Patent Application Publication
(10) Pub. No.: US 2005/0091824 A1
(43) Pub. Date: May 5, 2005

(54) Storage bin

(76) Inventors: Richard J. Epp, Fiske (CA); Dwayne S. Epp, Fiske (CA)

Correspondence Address: ADE & COMPANY, 1700-360 MAIN STREET, WINNIPEG, MB, R3C3Z3, CA

(21) Appl. No.: 10/839,802

(22) Filed: May 6, 2004

Related U.S. Application Data
(63) Continuation-in-part of application No. 10/192,685, filed on Jun. 20, 2002, now abandoned.

(51) Int. Cl. B23P 19/00; B23P 25/00

(52) U.S. Cl. 29/462; 29/525.01; 29/428

(57) ABSTRACT

A floor for a storage bin comprising a circular metal sheet defined by sheet pieces arranged for connection together with overlapping edges. The sheet pieces include a central circular piece. The sheet pieces include a plurality of generally pie-shaped pieces arranged for side by side connection along radial edges thereof so as to define a ring surrounding the central piece having a circular outer edge and with an inner circular edge defined by the pie-shaped pieces being connected to an outer edge of the central circular piece.

### FIELD OF THE INVENTION

This is a continuation-in-part application of application Ser. No. 10/192,685, filed Jun. 20, 2002.

The present invention relates to a storage bin, and more particularly a storage bin which can be transported and erected on site in relatively small pieces.

### BACKGROUND

The construction and shipment of storage bins generally consists of providing large panels of different sizes for constructing the floor for the supporting bin walls. The construction and shipment of these components can be costly, time consuming and complicated. Many types of bin floors required skilled workers to construct the floor and accurate measurements and supplies sometimes have to be carefully considered.

### SUMMARY

It is an object of the present invention to provide a method of erecting a storage bin which avoids or reduces the cost of transportation of large bin parts.

According to a first aspect of the present invention there is provided a method of erecting a storage bin for particulate materials comprising:
providing a metal floor comprising:
a plurality of separate sheet pieces arranged for connection together with horizontal overlapping edges to form a horizontal sheet metal floor panel;
each sheet piece being formed from sheet metal;
the sheet pieces including a central generally circular piece;
the sheet pieces including a plurality of outer generally pie-shaped pieces arranged for side by side connection along radial edges thereof so as to define a ring surrounding the central piece having a circular outer edge and with an inner circular edge defined by the pie-shaped pieces being arranged for connection to an outer edge of the central circular piece;
and a flange member for forming a ring around an outer edge of the floor panel;
the flange member being formed from angle iron with a horizontal flange and a vertical flange;
shipping the sheet pieces and the flange member as separate un-assembled elements to an assembly site;
at the assembly site connecting the sheet pieces together to form the sheet metal floor panel;
wherein each sheet piece is connected to a next adjacent sheet piece by a horizontal overlap connection formed by horizontal overlapping edge portions of the sheet metal forming the pieces;
wherein each horizontal overlap connection includes an overlying edge portion of one sheet piece for fastening to a corresponding underlying edge portion of a next adjacent sheet piece;
wherein the underlying edge portion is recessed by the thickness of the sheet metal so that an upper surface of the sheet metal floor panel is flat at the horizontal overlap connections;
attaching the flange member to the sheet metal floor panel at a position adjacent the outside edge thereof;
wherein the flange member is screw fastened through the horizontal flange to the sheet metal floor panel;
providing a cylindrical bin wall separate from the metal floor and having a bottom edge of the wall;
and, with the metal floor assembled at the assembly site, fastening the bottom edge of the bin wall to the vertical flange of the flange member.

Preferably the method includes providing a plurality of screw holes in the overlying edge portion and inserting self-tapping screws fastening to the corresponding underlying edge portion.

Preferably the method includes providing a plurality of projecting tabs arranged along one edge for co-operation with corresponding shaped slots in an adjacent edge of the next adjacent pie-shaped piece, inserting the tabs into the slots while the pie-shaped pieces are misaligned and sliding the pie-shaped pieces longitudinally each relative to the next to bring them into alignment wherein the tabs lock in the slots.

Preferably the tabs are formed in a first edge flange which is recessed below the main body of the pie-shaped piece and the slots are formed in a shoulder defined between the main body of the pie-shaped piece and a second edge flange which is recessed below the main body of the pie-shaped piece, the first and second edge flanges being arranged such that the main bodies of the pie pieces when connected define a horizontal flat floor at a constant height.

Preferably the flange member is spaced inwardly from the outer edge of the floor panel.

According to a second aspect of the invention there is provided a method of erecting a storage bin for particulate materials comprising:
providing a metal floor comprising:
a plurality of separate sheet pieces arranged for connection together with horizontal overlapping edges to form a horizontal sheet metal floor panel;
each sheet piece being formed from sheet metal;
the sheet pieces including a central generally circular piece;
the sheet pieces including a plurality of outer generally pie-shaped pieces arranged for side by side connection along radial edges thereof so as to define a ring surrounding the central piece having a circular outer edge and with an inner circular edge defined by the pie-shaped pieces being arranged for connection to an outer edge of the central circular piece;
shipping the sheet pieces as separate un-assembled elements to an assembly site;
at the assembly site connecting the sheet pieces together to form the sheet metal floor panel;
wherein each sheet piece is connected to a next adjacent sheet piece by a horizontal overlap connection formed by horizontal overlapping edge portions of the sheet metal forming the pieces;
wherein each horizontal overlap connection includes an overlying edge portion of one sheet piece for fastening to a corresponding underlying edge portion of a next adjacent sheet piece;
wherein the underlying edge portion is recessed by the thickness of the sheet metal so that an upper surface of the sheet metal floor panel is flat at the horizontal overlap connections;
providing a cylindrical bin wall separate from the metal floor;
providing the bin wall such that it consists solely of a plurality of rectangular wall pieces arranged in horizontal rows of the pieces side by side and vertical columns of the pieces one above another such that each piece in each row has a height from a top edge to a bottom edge forming a part of the height of the wall and each piece in each column has a width from a first side edge to a second side edge forming part of the peripheral extent of the wall, each piece having a right angle flange at each of its top, bottom and side edges which is fastened by fasteners to the corresponding flange of a next adjacent piece;
each piece having a curvature across its width between the side edges matching the curvature of the wall;
and, in respect to the bottom edge of a first row of the pieces fastening the flanges thereof to the floor panel.

According to a third aspect of the invention there is provided a method of erecting a storage bin for particulate materials comprising:
providing a sheet metal floor panel;
providing a cylindrical bin wall separate from the metal floor;
providing the bin wall such that it consists solely of a plurality of rectangular wall pieces arranged in horizontal rows of the pieces side by side and vertical columns of the pieces one above another such that each piece in each row has a height from a top edge to a bottom edge forming a part of the height of the wall and each piece in each column has a width from a first side edge to a second side edge forming part of the peripheral extent of the wall, each piece having a right angle flange at each of its top, bottom and side edges which is fastened by fasteners to the corresponding flange of a next adjacent piece;
each piece having a curvature across its width between the side edges matching the curvature of the wall;
and, in respect to the bottom edge of a first row of the pieces fastening the flanges thereof to the floor panel.

### BRIEF DESCRIPTION OF THE DRAWINGS

In the accompanying drawings, which illustrate an exemplary embodiment of the present invention:

FIG. 1 is a top plan view of the bin floor.

FIG. 2 is a vertical cross section along the lines 2-2 of FIG. 1.

FIG. 3 is a vertical cross section along the lines 3-3 of FIG. 1.

FIG. 4 is a vertical cross section along similar to that of FIG. 3 showing an alternative embodiment.

FIG. 5 is a top plan view of a part of the bin of the embodiment of FIG. 4.

FIG. 6 is a side elevational view of a part of the bin of the embodiment of FIG. 4.

FIG. 7 is a cross-sectional view similar to that of FIG. 2 showing an alternative arrangement for connection of the edge of one pie piece to the edge of the next.

FIG. 8 is a top plan view of the arrangement of FIG. 7.

### DETAILED DESCRIPTION

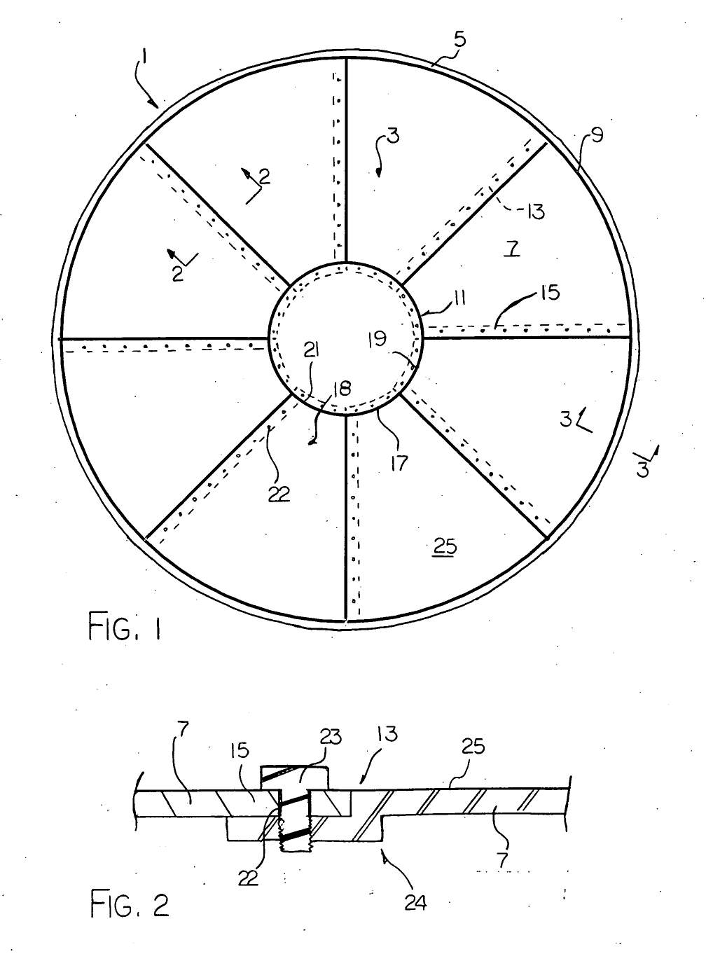

A storage bin 1 is arranged for storing items such as grain or the like, comprises a floor structure 3 to which is attached a conventional cylindrical wall 5 and a roof structure (not shown). The floor structure is formed from pie-shaped sheet metal panels 7. The sheets are arranged to fasten together to form a circular floor for the storage bin. Each sheet has an outer edge 9, an inner edge 11, an underlying side edge 13 and an overlapping side edge 15. Each sheet is arranged for side by side connection along radial edges such that the underlying edge corresponds with the overlapping edge of the adjacent sheet. The inner edge of the sheets are connected to and overlapped by a central circular piece 17. The connected sheets define a ring 18 surrounding the central piece having a circular outer edge 19 and with the inner edge defined by the pie-shaped pieces being connected to an outer overlapping edge 21 of the central circular piece. The overlapping edge of each sheet has a plurality of screw holes 22 for receiving self-tapping screws 23 for fastening to the underlying edge. The underlying edge is recessed 24 by the thickness of the sheet so that an upper surface 25 is flat, as best illustrated in FIG. 2. Each section having the same standard length from outer edge to inner edge width of each section from overlapping edge to underlying edge at the outer edge and inner edge respectively are sufficiently the same on each section. The sections are pre-fabricated at a manufacturing location and are transported so as to be assembled or erected on site, eliminating shipment of large panels for bin floors. The length of the sections are arranged such that one length can be used for different sized bins, providing ease of manufacture thus providing a less expensive floor structure for consumers. The bin floors do not necessitate the need for welding on site which will also keep the cost of construction to a minimum since the construction can mostly be done by a knowledgeable consumer.

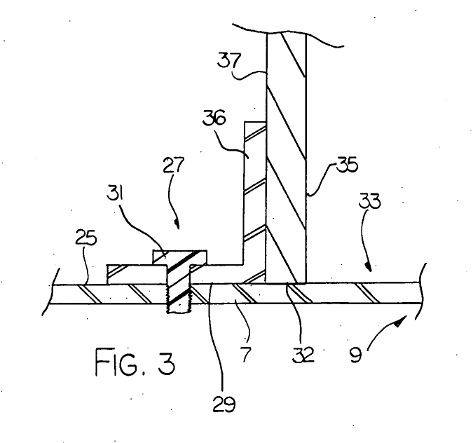

FIG. 3 shows a bin wall mounting arrangement 27. The bin wall has a circular horizontal bottom mounting flange 29 laying on the floor at a position adjacent the outer edge and fastened thereto such that a bottom edge 32 of the wall is flush against the floor. The flange as illustrated is a length of formed angle iron 36 which is fastened to an inner side 37 of the bin wall. The bin floor is constructed in a universal size such that the floor can be used for a variety of sized bins. The flange is spaced inwardly from the outer edge of the floor. The flange is fastened to the floor with self-tapping fasteners 31. The floor, according to the size of the bin, has an overlap 33 which varies wherein the outer edge of the floor extends outwardly from an outer side 35 of the wall. The bin wall is centred on the floor producing the overlap such that one diameter of floor is manufactured for different sized bins.

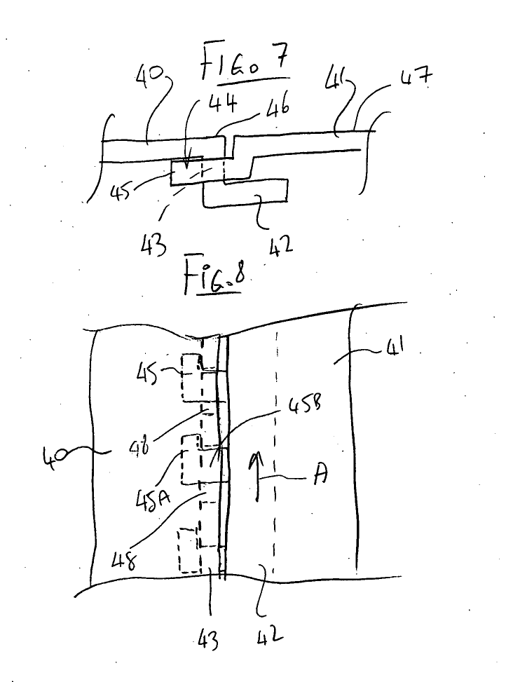

In the embodiment shown in FIGS. 1, 2 and 3, the pie pieces are connected edge to edge by self-tapping screws which pass through a hole in the top sheet and bite into the underlying edge of the underlying sheet to hold the sheet edges together. In FIGS. 7 and 8 is shown an alternative arrangement which avoids the use of screws or other fasteners at the overlying edges. In this arrangement the two pie pieces are shown and indicated at 40 and 41 respectively. The pie piece 40 has an edge flange 42 which underlies the edge of the pie piece 41. The pie piece 40 is bent to define a vertical leg portion 43 interconnecting the main body of the pie piece 40 with the flange 42. The vertical leg 43 has a length sufficient to receive the thickness of the edge of the pie piece 41 therein. The edge of the pie piece 41 has a flange portion 44 defining a plurality of tabs 45 which project outwardly from the pie piece along the edge of the pie piece. The tabs 45 are bent so that they lie in a plane underneath the pie piece 40 so as to project through slots in the leg 43. The flange 42 is at a height so that it underlies the edge flange 45. This arrangement thus provides upper surfaces 46 and 47 which are co-planar.

As shown in FIG. 8 the tabs have a wider end section 45A and a neck 45B connecting to the main body of the pie piece 41. The leg 43 has a series of slots 48 each arranged to receive a respective one of the tabs. The width of the slot along the length of the leg is equal to or dimensioned to receive the head 45A so that it is wider than the neck 45B.

The position shown in FIG. 8 is the assembled position after the pie pieces have been pushed together and the pie piece 41 moved in the direction of the arrow A. Thus in an initial connection step, the pie pieces are brought together in a slightly misaligned position so that the outer edge of the piece 41 projects beyond the outer edge of the piece 40 and the tabs are inserted into the slots in this misaligned position. The piece 41 is then moved along the arrow A sufficient to move the head longitudinally of the junction between the pieces so that it is no longer aligned with the slot 48 and is thus prevented from moving back through the slot thus holding the edges together. The inside edge of the pie pieces is then fastened by screws to the circular edge of the central piece thus holding the structure integral.

In the embodiment of FIGS. 1, 2 and 3, the construction of the bin wall is of a conventional nature in which the bin wall is attached to the bottom flange and stands upwardly therefrom. The bin wall is generally corrugated in a horizontal direction to provide the necessary vertical strength and stiffness of the wall.

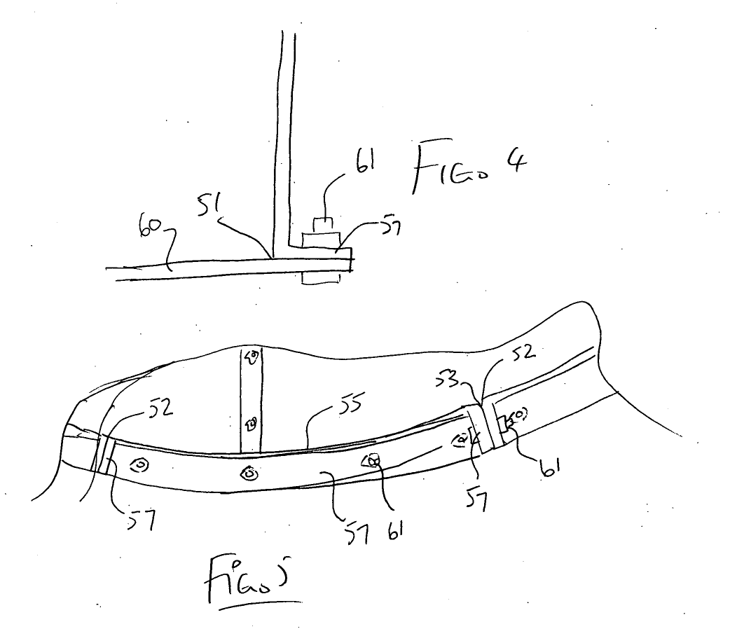

In the embodiment of FIGS. 4, 5 and 6 is shown an alternative arrangement for the bin wall construction. In this arrangement the bin wall is formed from a series of bin wall pieces, each of which is rectangular as shown in FIG. 6 to define a top edge 50, a bottom edge 51, a first side edge 52 and a second side edge 53. All of the pieces are identical and of the same dimensions. Typical dimensions might be of the order of 36 to 48 inches in width and 50 to 96 inches in height.

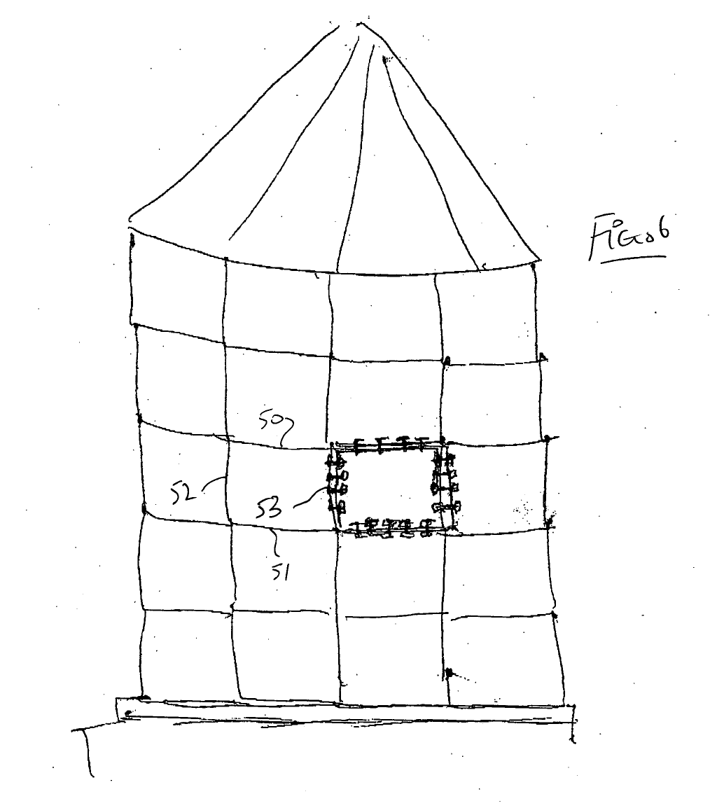

Each piece includes a main body 55 which is curved at a curvature matching the total curvature of the bin wall as shown in FIG. 5. Each of the top, bottom and side edges includes an out turned flange 57 which is arranged basically at right angles to the main body so as to project outwardly of the main body. The flanges around the peripheral edge of the piece thus provide a stiffening or strengthening effect of the piece so that it no longer requires corrugations or other separate strengthening elements and the main body is formed from a flat sheet simply curved into the shallowed curvature necessary to provide a radius of curvature equal to the radius of curvature of the bin, which might be of the order of 10 to 20 feet in radius.

Each of the pieces has the flanges thereof punched to provide aligned holes allowing each piece to be connected to the next adjacent piece at the corresponding flange so that the connection is provided by the fasteners through the holes and the wall system thus consists solely of the identical pieces arranged in rows and columns and the fasteners therebetween without additional strengthening elements being supplied. As shown in FIG. 4, the bottom flange 57 at the bottom edge 51 is connected to the floor 60 by bolts 61. As shown in FIG. 5 the flange at the first side edge 53 is connected to the flange at the second side edge 52 of the next adjacent piece by bolts 61.

While one embodiment of the present invention has been described in the foregoing, it is to be understood that other embodiments are possible within the scope of the invention. The invention is to be considered limited solely by the scope of the appended claims.

1. A method of erecting a storage bin for particulate materials comprising:
providing a metal floor comprising:
a plurality of separate sheet pieces arranged for connection together with horizontal overlapping edges to form a horizontal sheet metal floor panel;
each sheet piece being formed from sheet metal;
the sheet pieces including a central generally circular piece;
the sheet pieces including a plurality of outer generally pie-shaped pieces arranged for side by side connection along radial edges thereof so as to define a ring surrounding the central piece having a circular outer edge and with an inner circular edge defined by the pie-shaped pieces being arranged for connection to an outer edge of the central circular piece;
and a flange member for forming a ring around an outer edge of the floor panel;
the flange member being formed from angle iron with a horizontal flange and a vertical flange;
shipping the sheet pieces and the flange member as separate un-assembled elements to an assembly site;
at the assembly site connecting the sheet pieces together to form the sheet metal floor panel;
wherein each sheet piece is connected to a next adjacent sheet piece by a horizontal overlap connection formed by horizontal overlapping edge portions of the sheet metal forming the pieces;
wherein each horizontal overlap connection includes an overlying edge portion of one sheet piece for fastening to a corresponding underlying edge portion of a next adjacent sheet piece;
wherein the underlying edge portion is recessed by the thickness of the sheet metal so that an upper surface of the sheet metal floor panel is flat at the horizontal overlap connections;
attaching the flange member to the sheet metal floor panel at a position adjacent the outside edge thereof;
wherein the flange member is screw fastened through the horizontal flange to the sheet metal floor panel;
providing a cylindrical bin wall separate from the metal floor and having a bottom edge of the wall;
and, with the metal floor assembled at the assembly site, fastening the bottom edge of the bin wall to the vertical flange of the flange member.

2. The method according to claim 1 including providing a plurality of screw holes in the overlying edge portion and inserting self-tapping screws fastening to the corresponding underlying edge portion.

3. The method according to claim 1 including providing a plurality of projecting tabs arranged along one edge for co-operation with corresponding shaped slots in an adjacent edge of the next adjacent pie-shaped piece, inserting the tabs into the slots while the pie-shaped pieces are misaligned and sliding the pie-shaped pieces longitudinally each relative to the next to bring them into alignment wherein the tabs lock in the slots.

4. The method according to claim 3 wherein the tabs are formed in a first edge flange which is recessed below the main body of the pie-shaped piece and the slots are formed in a shoulder defined between the main body of the pie-shaped piece and a second edge flange which is recessed below the main body of the pie-shaped piece, the first and second edge flanges being arranged such that the main bodies of the pie pieces when connected define a horizontal flat floor at a constant height.

5. The method according to claim 1 wherein the flange member is spaced inwardly from the outer edge of the floor panel.

6. A method of erecting a storage bin for particulate materials comprising:
providing a metal floor comprising:
a plurality of separate sheet pieces arranged for connection together with horizontal overlapping edges to form a horizontal sheet metal floor panel;
each sheet piece being formed from sheet metal;
the sheet pieces including a central generally circular piece;
the sheet pieces including a plurality of outer generally pie-shaped pieces arranged for side by side connection along radial edges thereof so as to define a ring surrounding the central piece having a circular outer edge and with an inner circular edge defined by the pie-shaped pieces being arranged for connection to an outer edge of the central circular piece;
shipping the sheet pieces as separate un-assembled elements to an assembly site;
at the assembly site connecting the sheet pieces together to form the sheet metal floor panel;
wherein each sheet piece is connected to a next adjacent sheet piece by a horizontal overlap connection formed by horizontal overlapping edge portions of the sheet metal forming the pieces;
wherein each horizontal overlap connection includes an overlying edge portion of one sheet piece for fastening to a corresponding underlying edge portion of a next adjacent sheet piece;
wherein the underlying edge portion is recessed by the thickness of the sheet metal so that an upper surface of the sheet metal floor panel is flat at the horizontal overlap connections;
providing a cylindrical bin wall separate from the metal floor;
providing the bin wall such that it consists solely of a plurality of rectangular wall pieces arranged in horizontal rows of the pieces side by side and vertical columns of the pieces one above another such that each piece in each row has a height from a top edge to a bottom edge forming a part of the height of the wall and each piece in each column has a width from a first side edge to a second side edge forming part of the peripheral extent of the wall, each piece having a right angle flange at each of its top, bottom and side edges which is fastened by fasteners to the corresponding flange of a next adjacent piece;
each piece having a curvature across its width between the side edges matching the curvature of the wall;
and, in respect to the bottom edge of a first row of the pieces fastening the flanges thereof to the floor panel.

7. The method according to claim 6 including providing a plurality of screw holes in the overlying edge portion and inserting self-tapping screws fastening to the corresponding underlying edge portion.

8. The method according to claim 6 including providing a plurality of projecting tabs arranged along one edge for co-operation with corresponding shaped slots in an adjacent edge of the next adjacent pie-shaped piece, inserting the tabs into the slots while the pie-shaped pieces are misaligned and sliding the pie-shaped pieces longitudinally each relative to the next to bring them into alignment wherein the tabs lock in the slots.

9. The method according to claim 8 wherein the tabs are formed in a first edge flange which is recessed below the main body of the pie-shaped piece and the slots are formed in a shoulder defined between the main body of the pie-shaped piece and a second edge flange which is recessed below the main body of the pie-shaped piece, the first and second edge flanges being arranged such that the main bodies of the pie pieces when connected define a horizontal flat floor at a constant height.

10. The method according to claim 1 wherein the flanges of the bottom row are spaced inwardly from the outer edge of the floor panel.

11. A method of erecting a storage bin for particulate materials comprising:
providing a sheet metal floor panel;
providing a cylindrical bin wall separate from the metal floor;
providing the bin wall such that it consists solely of a plurality of rectangular wall pieces arranged in horizontal rows of the pieces side by side and vertical columns of the pieces one above another such that each piece in each row has a height from a top edge to a bottom edge forming a part of the height of the wall and each piece in each column has a width from a first side edge to a second side edge forming part of the peripheral extent of the wall, each piece having a right angle flange at each of its top, bottom and side edges which is fastened by fasteners to the corresponding flange of a next adjacent piece;
each piece having a curvature across its width between the side edges matching the curvature of the wall;
and, in respect to the bottom edge of a first row of the pieces fastening the flanges thereof to the floor panel.
